(19) United States
(12) Patent Application Publication
(10) Pub. No.: US 2017/0115516 A1
(43) Pub. Date: Apr. 27, 2017

(54) OPTICAL FILM AND DISPLAY DEVICE

(71) Applicants: SAMSUNG ELECTRONICS CO., LTD., Suwon-si (KR); SAMSUNG SDI CO., LTD., Yongin-si (KR)

(72) Inventors: Jong Hoon WON, Yongin-si (KR); Sangah GAM, Seoul (KR); Hye Young KONG, Uijeongbu-si (KR); Hyung Jun KIM, Suwon-si (KR); Myungsup JUNG, Seongnam-si (KR)

(21) Appl. No.: 15/050,886

(22) Filed: Feb. 23, 2016

(30) Foreign Application Priority Data
Oct. 22, 2015 (KR) 10-2015-0147568

(51) Int. Cl. G02F 1/1335

(52) U.S. Cl. CPC G02F 1/1335

(57) ABSTRACT

An optical film including an elongation film including a hydrophobic polymer and a dichroic dye, and a brightness enhancement film disposed on the elongation film.

### CROSS-REFERENCE TO RELATED APPLICATION

This application claims priority to and the benefit of Korean Patent Application No. 10-2015-0147568 filed in the Korean Intellectual Property Office on Oct. 22, 2015, the content of which is incorporated herein in its entirety by reference.

### BACKGROUND

1. Field

An optical film and a display device are disclosed.

2. Description of the Related Art

A display device such as a liquid crystal display (LCD) and an organic light emitting diode (OLED) includes a polarizing plate attached to the outside of the display panel. The polarizing plate only transmits light of a specific wavelength and absorbs or reflects other light, so it may control the direction of the incident light on the display panel or the light emitted from the display panel.

The polarizing plate generally includes a polarizer and a protective layer for the polarizer. The polarizer may include, for example, an iodine dye or a dichroic dye adsorbed in and arranged on polyvinyl alcohol (PVA), and the protecting layer may use, for example, triacetyl cellulose (TAC).

However, the polarizing plate including the polarizer and the protecting layer not only involves a complicated process and high production costs, but also leads to a thick polarizing plate, which causes an increased thickness of a display device.

Thus, there remains a need for an optical film capable of decreasing a thickness and improving optical properties of the display device.

### SUMMARY

An embodiment provides an optical film capable of decreasing a thickness and improving optical properties.

Another embodiment provides a display device including the optical film.

According to an embodiment, an optical film includes an elongation film including a hydrophobic polymer and a dichroic dye, and a brightness enhancement film disposed on the elongation film.

The elongation film may be a melt-blend of the hydrophobic polymer and the dichroic dye, and may be elongated in a uniaxial direction.

The hydrophobic polymer may include a polyolefin, a polyamide, a polyester, a polyacryl, a polystyrene, a copolymer thereof, or a combination thereof.

The dichroic dye may be represented by Chemical Formula 1.

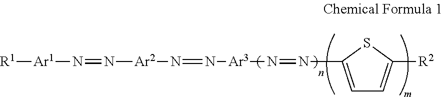

In Chemical Formula 1,

Ar¹ to Ar³ are independently a substituted or unsubstituted C6 to C15 arylene group,

R¹ is a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof,

R² is hydrogen, a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof, and

n and m are independently 0 or 1.

The elongation film may have a thickness of less than or equal to about 50 micrometers.

The brightness enhancement film may include a plural layer having different refractive indices.

The brightness enhancement film may include a plurality of light transmittance particulates.

The brightness enhancement film may include a plurality of anisotropic particles.

The brightness enhancement film may include a liquid crystal.

The brightness enhancement film may include a nano wire grid polarizer.

The brightness enhancement film may include a multi-layered reflection polarizer.

The elongation film and the brightness enhancement film may be directly bonded to each other or may be interposed by an adhesive or a bonding agent.

The optical film may satisfy transmittance of about 20% to about 50% and a degree of polarization of greater than or equal to about 90%.

The optical film may have a thickness of about 30 micrometers to about 100 micrometers.

According to another embodiment, a display device including a display panel and the optical film disposed on the display panel is provided.

The display panel may be a liquid crystal display panel or an organic light emitting display panel.

According to another embodiment, a display device includes a light source, a liquid crystal display panel, and the optical film disposed between the light source and the liquid crystal display panel.

The elongation film may be disposed at the side of the liquid crystal display panel, and the brightness enhancement film may be disposed at the side of the light source.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic cross-sectional view showing an optical film according to an embodiment,

FIG. 2 is a cross-sectional view showing the elongation film of the optical film of FIG. 1,

FIG. 3 is a cross-sectional view showing a liquid crystal display (LCD) according to an embodiment, and

FIG. 4 is a cross-sectional view showing an organic light emitting diode (OLED) display according to an embodiment.

### DETAILED DESCRIPTION

Exemplary embodiments of the present disclosure will hereinafter be described in detail, and may be easily performed by those who have common knowledge in the related art. However, this disclosure may be embodied in many different forms, and is not construed as limited to the exemplary embodiments set forth herein; rather, these embodiments are provided so that this disclosure will fully convey the scope of the disclosure to those skilled in the art. Thus, in some exemplary embodiments, well known technologies are not specifically explained to avoid ambiguous understanding of the present inventive concept. Accordingly, the exemplary embodiments are merely described below, by referring to the figures, to explain aspects of the present inventive concept. Expressions such as “at least one of,” when preceding a list of elements, modify the entire list of elements and do not modify the individual elements of the list. Unless otherwise defined, all terms used in the specification (including technical and scientific terms) may be used with meanings commonly understood by a person having ordinary knowledge in the art to which this invention belongs. Further, unless explicitly defined to the contrary, the terms defined in a generally-used dictionary should be interpreted as having a meaning that is consistent with their meaning in the context of the relevant art and the present disclosure, and are not ideally or excessively interpreted. In addition, unless explicitly described to the contrary, the word “comprise” and variations such as “comprises” or “comprising”, and the word “include” and variations such as “includes” or “including”, when used in this specification, specify the presence of stated features, regions, integers, steps, operations, elements, and/or components, but do not preclude the presence or addition of one or more other features, regions, integers, steps, operations, elements, components, and/or groups thereof. Therefore, the above words will be understood to imply the inclusion of stated elements but not the exclusion of any other elements.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As stated above, unless specifically described to the contrary, a singular form includes a plural form.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

As used herein, when a definition is not otherwise provided, the term “substituted” refers to one substituted with at least one substituent selected from a C1 to C20 alkyl group, a C1 to C20 aryl group, a C2 to C20 alkenyl group, a C2 to C20 alkynyl group, and a combination thereof, instead of hydrogen of a functional group or a compound.

As used herein, when a definition is not otherwise provided, the term “hetero” refers to one including 1 to 3 heteroatoms selected from N, O, S, and P.

As used herein, when a definition is not otherwise provided, the term “alkyl group” may refer to a group derived from a straight or branched chain saturated aliphatic hydrocarbon having the specified number of carbon atoms and having a valence of at least one.

As used herein, when a definition is not otherwise provided, the term “alkoxy group” may refer to “alkyl-O—”, wherein the term “alkyl” has the same meaning as described above.

As used herein, when a definition is not otherwise provided, the term “alkylthio group” may refer to “alkyl-S—”, wherein the term “alkyl” has the same meaning as described above.

As used herein, when a definition is not otherwise provided, the term “alkenyl group” may refer to a straight or branched chain, monovalent hydrocarbon group having at least one carbon-carbon double bond.

As used herein, when a definition is not otherwise provided, the term “alkynyl group” may refer to a straight or branched chain, monovalent hydrocarbon group having at least one carbon-carbon triple bond.

As used herein, when a definition is not otherwise provided, the term “cycloalkyl group” may refer to a monovalent group having one or more saturated rings in which all ring members are carbon.

As used herein, when a definition is not otherwise provided, the term “aryl”, which is used alone or in combination, may refer to an aromatic hydrocarbon containing at least one ring and having the specified number of carbon atoms. The term “aryl” may be construed as including a group with an aromatic ring fused to at least one cycloalkyl ring.

As used herein, when a definition is not otherwise provided, the term “heteroaryl group” may refer to an aryl group including carbon and 1 to 3 heteroatoms selected from the group consisting of N, O, S, and P as ring atoms.

As used herein, when a definition is not otherwise provided, the term “arylene group” may refer to a functional group having a valence of at least two obtained by removal of two hydrogens in an aromatic ring, optionally substituted with one or more substituents where indicated, provided that the valence of the alkylene group is not exceeded.

As used herein, when a definition is not otherwise provided, the term “heteroarylene group” may refer to a functional group having a valence of at least two obtained by removal of two hydrogens in an aromatic ring, containing one to three heteroatoms selected from the group consisting of N, O, S, Si, and P as ring-forming elements, optionally substituted with one or more substituents where indicated, provided that the valence of the alkylene group is not exceeded.

As used herein, the alkyl group, alkylthio group, alkenyl group, and alkynyl group may be branched or linear.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C₁-C₂₀ alkyl” refers to a C₁-C₂₀ alkyl group substituted with C₆-C₂₀ aryl group, the total number of carbon atoms in the resulting aryl substituted alkyl group is C₇-C₄₀.

Hereinafter, an optical film according to an embodiment is described.

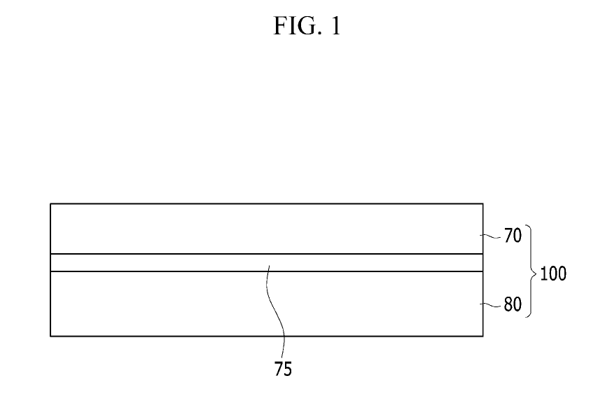

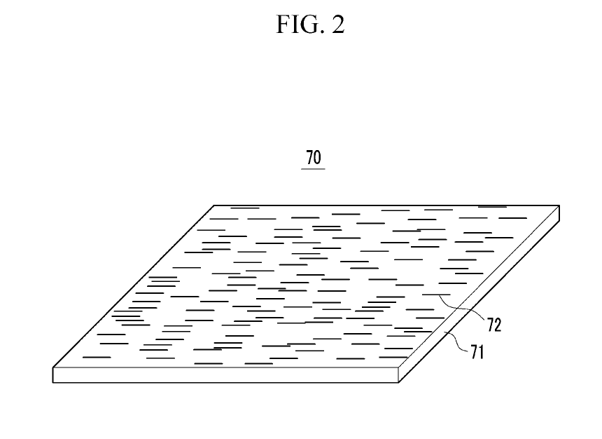

FIG. 1 is a schematic cross-sectional view showing an optical film according to an embodiment, and FIG. 2 is a cross-sectional view showing the elongation film of the optical film of FIG. 1.

Referring to FIG. 1, an optical film 100 according to an embodiment includes an elongation film 70 and a brightness enhancement film 80.

Referring to FIG. 2, the elongation film 70 includes a polymer 71 and a dichroic dye 72, and the dichroic dye 72 is dispersed in the polymer 71 and is elongated in a uniaxial direction.

The polymer 71 may be a hydrophobic polymer, for example a polyolefin such as polyethylene (PE), polypropylene (PP), and a copolymer thereof; a polyamide such as nylon and aromatic polyamide; a polyester such as polyethylene terephthalate (PET), polyethyleneterephthalate glycol (PETG) and polyethylenenaphthalate (PEN); a polyacrylate such as polymethyl(meth)acrylate; a polystyrene such as polystyrene (PS) and an acrylonitrile-styrene copolymer; a polycarbonate; a vinyl chloride; a polyimide; a sulfone; a polyethersulfone; a polyether-ether ketone; a polyphenylene sulfide; a vinyl alcohol; a vinylidene chloride; a vinyl butyral; an allylate; a polyoxymethylene; an epoxy, a copolymer thereof, or a combination thereof.

The polymer 71 may be, for example polyethylene (PE), polypropylene (PP), polyethyleneterephthalate (PET), polyethyleneterephthalate glycol (PETG), polyethylenenaphthalate (PEN), nylon, a copolymer thereof, or a combination thereof.

The polymer 71 may be, for example a mixture of at least two selected from polyethylene (PE), polypropylene (PP), a polyethylene-polypropylene copolymer (PE-PP), and may be, for example a mixture of polypropylene (PP) and a polyethylene-polypropylene copolymer (PE-PP).

The polypropylene (PP) may have, for example, a melt flow index (MFI) of about 0.1 grams per 10 minutes (g/10 min) to about 5 g/10 min. Herein, the melt flow index (MFI) shows the amount of a polymer in a melt state flowing per 10 minutes, and relates to viscosity of the polymer in a melted state. In other words, as the melt flow index (MFI) becomes lower, the polymer has higher viscosity, while as the melt flow index (MFI) becomes higher, the polymer has lower viscosity. While not wishing to be bound by theory, it is understood that when the polypropylene (PP) has a melt flow index (MFI) within the above range, properties of a final product as well as workability may be effectively improved. For example, the polypropylene may have a melt flow index (MFI) ranging from about 0.5 g/10 min to about 5 g/10 min.

The polyethylene-polypropylene copolymer (PE-PP) may include about 1 percent by weight (wt %) to about 50 wt % of an ethylene group based on the total amount of the copolymer. While not wishing to be bound by theory, it is understood that when the polyethylene-polypropylene copolymer (PE-PP) includes the ethylene group within the above range, phase separation of the polypropylene and the polyethylene-polypropylene copolymer (PE-PP) may be effectively prevented or suppressed. In addition, the polyethylene-polypropylene copolymer (PE-PP) may improve an elongation rate during elongation and may have excellent light transmittance and alignment, improving polarization characteristics. For example, the polyethylene-polypropylene copolymer (PE-PP) may include an ethylene group in an amount of about 1 wt % to about 25 wt % based on the total amount of the copolymer.

The polyethylene-polypropylene copolymer (PE-PP) may have a melt flow index (MFI) ranging from about 5 g/10 min to about 15 g/10 min. While not wishing to be bound by theory, it is understood that when the polyethylene-polypropylene copolymer (PE-PP) has a melt flow index (MFI) within the above range, properties of a final product as well as workability may be effectively improved. For example, the polyethylene-polypropylene copolymer (PE-PP) may have a melt flow index (MFI) ranging from about 10 g/10 min to about 15 g/10 min.

The polymer 71 may include the polypropylene (PP) and the polyethylene-polypropylene copolymer (PE-PP) in a weight ratio of about 1:9 to about 9:1. While not wishing to be bound by theory, it is understood that when the polypropylene (PP) and the polyethylene-polypropylene copolymer (PE-PP) are included within the above range, the polypropylene may be prevented from crystallizing and may have excellent mechanical strength, thus effectively improving the haze characteristics. For example, the polymer 71 may include the polypropylene (PP) and the polyethylene-polypropylene copolymer (PE-PP) in a weight ratio of about 4:6 to about 6:4, for example, in a weight ratio of about 5:5.

The polymer 71 may have a melt flow index (MFI) ranging from about 1 g/10 min to about 15 g/10 min. While not wishing to be bound by theory, it is understood that when the polymer 71 has a melt flow index (MFI) within the above range, the polyolefin may not only secure excellent light transmittance, since crystals are not excessively formed in the polymer, but may also have appropriate viscosity for manufacturing a film, and thus have improved workability. For example, the polymer 71 may have a melt flow index (MFI) ranging from about 5 g/10 min to about 15 g/10 min.

The polymer 71 may have haze ranging from less than or equal to about 5%. While not wishing to be bound by theory, it is understood that when the polyolefin 71 has haze within the above range, transmittance may be increased, and thus excellent optical properties may be secured. For example, the polymer 71 may have haze of less than or equal to about 2 percent (%), and in another example, about 0.5% to about 2%.

The polymer 71 may have crystallinity of less than or equal to about 50%. While not wishing to be bound by theory, it is understood that when the polymer 71 has crystallinity within the above range, the polyolefin may have lower haze and accomplish excellent optical properties. For example, the polymer 71 may have crystallinity of about 30% to about 50%.

The polymer 71 may have light transmittance of greater than or equal to about 85% in a wavelength region of about 380 nanometers (nm) to about 780 nm. The polymer 71 may be elongated in a uniaxial direction. The uniaxial direction may be the length direction of the dichroic dye 72.

The dichroic dye 72 is dispersed in the polymer 71 and aligned in the elongation direction of the polymer 71. The dichroic dye 72 transmits one perpendicular polarization component out of two perpendicular polarization components in a predetermined wavelength region.

The dichroic dye 72 may include one or more dichroic dyes, for example a plurality of dichroic dyes having different absorption wavelength regions from each other. For example, the plurality of dichroic dyes 72 are combined to have an absorption wavelength region in a whole range of a visible ray region, that is about 380 nm to about 780 nm.

For example, the dichroic dye 72 may include, at least two of at least one first dichroic dye having a maximum absorption wavelength in about 380 nm to about 490 nm, at least one second dichroic dye having a maximum absorption wavelength in about 490 nm to about 580 nm, and at least one third dichroic dye having a maximum absorption wavelength in about 580 nm to about 780 nm. The first, second and third dichroic dyes may be, for example a yellow dye, a magenta dye, and a cyan dye, but are not limited thereto.

The dichroic dye 72 may be, for example an azo compound, and may be, for example represented by Chemical Formula 1.

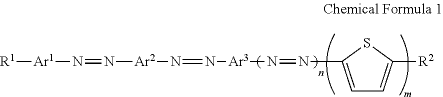

In Chemical Formula 1,

Ar¹ to Ar³ are independently a substituted or unsubstituted C6 to C15 arylene group,

R¹ is a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof,

R² is hydrogen, a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof, and

n and m are independently 0 or 1.

In Chemical Formula 1, Ar¹ to Ar³ may include, for example a substituted or unsubstituted phenylene group, a substituted or unsubstituted naphthylene group, or a substituted or unsubstituted biphenylene group. Herein the substituted phenylene group, the substituted naphthylene group and the substituted biphenylene group may be, for example substituted with a C1 to C20 alkyl group, a substituted or unsubstituted C1 to C20 alkoxy group, a halogen, a halogen-containing group, or a combination thereof.

In Chemical Formula 1, R¹ may be a substituted or unsubstituted C1 to C30 alkyl group, a substituted or unsubstituted C1 to C20 alkoxy group, a substituted or unsubstituted C1 to C20 alkylthio group, a substituted or unsubstituted C1 to C30 ketone group, a substituted or unsubstituted C1 to C30 oxycarbonyl group, a substituted or unsubstituted C2 to C20 alkenyl group, a substituted or unsubstituted C2 to C30 alkynyl group, or a combination thereof, and

R² may be hydrogen, a substituted or unsubstituted C1 to C30 alkyl group, a substituted or unsubstituted C6 to C20 aryl group, C1 to C20 alkoxy group, a substituted or unsubstituted C1 to C20 alkylthio group, —NR³R⁴, or a combination thereof, wherein R³ and R⁴ are independently hydrogen, a substituted or unsubstituted C1 to C10 alkyl group or are linked to each other to provide a ring.

The decomposition temperature of the dichroic dye 72 may be greater than or equal to about 245° C. Herein, the decomposition temperature indicates a temperature where the weight of the dichroic dye 72 decreases by about 5% relative to its initial weight.

The dichroic dye 72 may be included in an amount of about 0.01 to about 10 parts by weight based on 100 parts by weight of the polymer 71. While not wishing to be bound by theory, it is understood that within the above range, sufficient polarization characteristics may be obtained without deteriorating transmittance of the elongation film. Within the above range, the dichroic dye 72 may be included in an amount of about 0.05 to about 5 parts by weight based on 100 parts by weight of the polymer 71.

The elongation film 70 may have, for example a dichroic ratio of about 2 to about 14 in about 450 nm to about 550 nm. The elongation film 70 may have, for example a dichroic ratio of about 2 to about 14 in about 380 nm to about 650 nm.

Herein, the dichroic ratio is a value obtained by dividing linear polarization absorption in a direction perpendicular to the axis of the polymer by polarization absorption in a direction parallel to the polymer, and may be obtained from Equation 1.

DR=Log(1/T_{⊥})/Log(1/T_{//}) Equation 1

In Equation 1,

DR is a dichroic ratio of an elongation film,

T_{II} is light transmittance of light entering parallel to the transmissive axis of a elongation film, and

T_{⊥} is light transmittance of light entering perpendicular to the transmissive axis of the elongation film.

The dichroic ratio denotes a degree that the dichroic dye 72 is aligned in one direction in the elongation film 70. The elongation film 70 has a dichroic ratio within the above range in a predetermined wavelength range, which leads the dichroic dye 72 to be aligned along the alignment of a polymer chain, and thus may improve the polarizing characteristics while decreasing reflection to be about 10% or less.

The elongation film 70 may have light transmittance of greater than or equal to about 30%, for example light transmittance of about 30% to about 95%. While not wishing to be bound by theory, it is understood that when it has light transmittance within the above range, light emission from one side of a display on which the elongation film 70 is applied may be prevented.

The elongation film 70 may be a melt blend of the polymer 71 and the dichroic dye 72. The melt blend may be obtained by melt-blending the polymer 71 and the dichroic dye 72 at a temperature of greater than or equal to the melting point of the polymer 71.

For example, the elongation film 70 may be manufactured by mixing and elongating the polymer 71 and the dichroic dye 72.

In another example, the elongation film 70 may be, for example, manufactured by melt-blending a polymer and a dichroic dye, putting the melt blend into a mold to manufacture a sheet, and elongating the sheet in a uniaxial direction.

The melt blending of the polymer and the dichroic dye may be performed at a temperature of less than or equal to about 300° C., for example, ranging from about 50 to about 300° C.

The sheet may be formed by placing the melt blend in the mold, and pressing it with a high pressure or discharging it in a chill roll through a T-die.

The elongation in a uniaxial direction may be performed at a temperature ranging from about 30 to about 200° C. at an elongation rate ranging from about 400% to about 1,000%. The elongation rate refers to a length ratio of after the elongation to before the elongation of the sheet, and means the elongation extent of the sheet after uniaxial elongation.

The elongation film 70 may have a relatively low thickness of less than or equal to about 50 micrometers (μm), for example about 5 μm to about 50 μm. While not wishing to be bound by theory, it is understood that when the elongation film 70 has a thickness within the above range, it may be significantly thinner than a polarizing plate requiring a protecting layer such as triacetyl cellulose (TAC) and contribute to realizing a thin display device.

The brightness enhancement film 80 is positioned on one side of the elongation film 70.

The brightness enhancement film 80 is a film capable of improving brightness by increasing a usable light dose by reflection and/or scattering characteristics, and thus may improve a usable light dose by reflecting and/or scattering a part of or the entire light absorbed in the elongation film 70 polarizing a light from a light source or natural light.

The brightness enhancement film 80 may have any structure capable of improving brightness by reflecting and/or scattering characteristics without a particular limit.

For example, the brightness enhancement film 80 may have a structure where multi-layers having different refractive indexes are stacked. Herein, the brightness enhancement film 80 may have a structure that a high refractive index layer and a low refractive index layer are alternatively stacked, for example, a structure that about 3 layers to about 50 layers are stacked. The high refractive index layer and the low refractive index layer may be for example, made of a conductor such as a metal and a conductive oxide, a dielectric material, or a combination thereof.

For example, the brightness enhancement film 80 may include a plurality of light transmittance particulates. The plurality of light transmittance particulates may reflect and/or scatter incident light, and thus increase a light dose.

For example, the brightness enhancement film 80 may include a plurality of anisotropic particles. The anisotropic particles may be for example liquid crystals.

For example, the brightness enhancement film 80 may include a nano wire grid polarizer. The nano wire grid polarizer may have a structure that a plurality of metal nano wires is arranged along one direction.

For example, the brightness enhancement film 80 may include a multi-layered reflection polarizer. The multi-layered reflection polarizer may have a structure that multi-layers having different structures, for example, more than one isotropic layer and anisotropic layer are stacked. The multi-layered reflection polarizer may be for example a dual brightness enhancement film.

The brightness enhancement film 80 may for example have a thickness ranging from about 10 μm to about 200 μm. For example, the brightness enhancement film 80 may for example have a thickness ranging from about 10 μm to about 160 μm within the above range, in another example, from about 10 μm to about 100 μm within the above range, and in still another example, from about 10 μm to about 50 μm within the above range.

The elongation film 70 and the brightness enhancement film 80 are bonded by disposing the bonding layer 75 including an adhesive or a bonding agent therebetween. However, the elongation film 70 and the brightness enhancement film 80 may be directly bonded without the bonding layer 75.

The optical film 100 may have for example a thickness ranging from about 30 μm to about 250 μm, and thus is relatively thin. The optical film 100 may have for example a thickness ranging from about 30 μm to about 200 μm within the above range, for example, about 30 μm to about 150 μm within the above range, and in another example, from about 30 μm to about 100 μm within the above range. Accordingly, a thin display device may be realized.

The optical film 100 may satisfy, for example about 20% to about 50% of transmittance and a degree of polarization of greater than or equal to 90%. Within the above range, the optical film 100 may satisfy, for example transmittance of about 30% to about 50% and a degree of polarization of about 93% to about 100%, or transmittance of about 35% to about 50% and a degree of polarization of about 95 to about 99.9%.

The optical film 100 has a self-integrated structure of the elongation film 70 having a lower thickness and the brightness enhancement film 80, and thus may have a lower thickness and simultaneously improve brightness. The optical film 100 having the self-integrated structure of the elongation film 70 and the brightness enhancement film 80 is applied to realize a thin display device having improved optical properties.

The optical film 100 may be applied to various display devices.

A display device includes a display panel and an optical film 100 positioned on one side of the display panel.

The display panel may be, for example a liquid crystal display panel or organic light emitting display panel.

The display device may be a liquid crystal display (LCD).

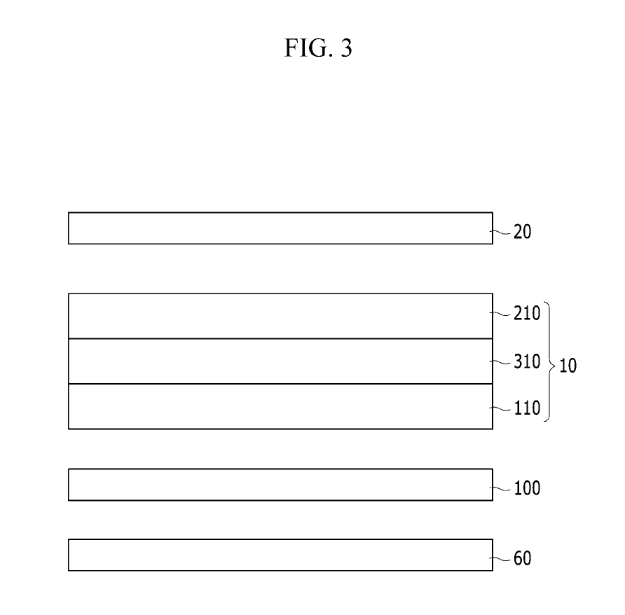

FIG. 3 is a cross-sectional view showing a liquid crystal display (LCD) according to an embodiment.

Referring to FIG. 3, a liquid crystal display (LCD) according to an embodiment includes a light source region 60; a liquid crystal display panel 10; a polarizer 20 disposed on the liquid crystal display panel 10; and the optical film 100 disposed between the light source region 60 and the liquid crystal display panel 10.

The light source region 60 may include a light source supplying light and optionally at least one optical sheet. The light source may be, for example, a cold cathode fluorescent lamp (CCFL), a light emitting diode (LED), a quantum dot (QD), and/or the like, and the optical sheet may be, for example, a prism sheet, a diffuser sheet, a light guide, and/or the like.

The liquid crystal display panel 10 may be a twist nematic (TN) mode panel, a vertical alignment (PVA) mode panel, an in-plane switching (IPS) mode panel, an optically compensated bend (OCB) mode panel, or the like.

The liquid crystal display panel 10 may include a first display panel 110, a second display panel 210 and a liquid crystal layer 310 interposed between the first display panel 110 and the second display panel 210.

The first display panel 110 may include, for example, a thin film transistor (not shown) formed on a substrate (not shown) and a first electric field generating electrode (not shown) connected to the same, and the second display panel 210 may include, for example, a color filter (not shown) formed on a substrate (not shown) and a second electric field generating electrode (not shown). However, it is not limited thereto, and the color filter may be included in the first display panel 110, while the first electric field generating electrode and the second electric field generating electrode may be disposed on the first display panel 110 together therewith.

The liquid crystal layer 310 may include a plurality of liquid crystal molecules. The liquid crystal molecules may have positive or negative dielectric anisotropy. When the liquid crystal molecules have positive dielectric anisotropy, the major axes thereof may be aligned substantially parallel to the surface of the first display panel 110 and the second display panel 210 when an electric field is not applied, and the major axes may be aligned substantially perpendicular to the surface of the first display panel 110 and the second display panel 210 when an electric field is applied. On the other hand, when the liquid crystal molecules have negative dielectric anisotropy, the major axes may be aligned substantially perpendicular to the surface of the first display panel 110 and the second display panel 210 when an electric field is not applied, and the major axes may be aligned substantially parallel to the surface of the first display panel 110 and the second display panel 210 when an electric field is applied.

The polarizer 20 may be disposed on the liquid crystal display panel 10, that is at the side of a viewer.

The polarizer 20 may be, for example the elongation film 70 of the polymer 71 and the dichroic dye 72, or may be, for example a polarizer including polyvinyl alcohol (PVA) and a protection film.

The optical film 100 may be disposed between the light source region 60 and the liquid crystal display panel 10, and is the same as described above. Herein, the elongation film 70 may be disposed at the side of the liquid crystal display panel 10, and the brightness enhancement film 80 may be disposed at the side of the light source region 60.

The display device may be an organic light emitting diode (OLED) display.

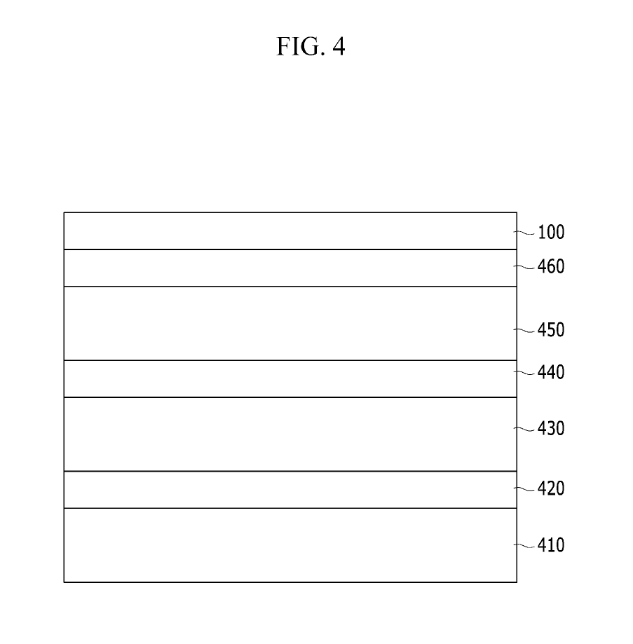

FIG. 4 is a cross-sectional view showing an organic light emitting diode (OLED) display according to an embodiment.

Referring to FIG. 4, the organic light emitting display according to an embodiment includes a base substrate 410, a lower electrode 420, an organic emission layer 430, an upper electrode 440, an encapsulation substrate 450, a retardation film 460, and the optical film 100.

The base substrate 410 may be made of glass or plastic.

At least one of the lower electrode 420 and the upper electrode 440 may be an anode, and the other one may be a cathode. The anode is an electrode injected with holes, and may be made of a transparent conductive material having a high work function to transmit the emitted light to the outside, for example, ITO or IZO. The cathode is an electrode injected with electrons, and may be made of a conductive material having a low work function and not affecting the organic material, and may be selected from, for example, aluminum (Al), calcium (Ca), and barium (Ba).

The organic emission layer 430 includes an organic material which may emit light when applying a voltage to the lower electrode 420 and the upper electrode 440.

An auxiliary layer (not shown) may be further provided between the lower electrode 420 and the organic emission layer 430 and between the upper electrode 440 and the organic emission layer 430. The auxiliary layer is used to balance electrons and holes, and may include a hole transport layer, a hole injection layer (HIL), an electron injection layer (EIL), and an electron transporting layer.

The encapsulation substrate 450 may be made of glass, metal, or a polymer, and may seal the lower electrode 420, the organic emission layer 430, and the upper electrode 440 to prevent moisture and/or oxygen inflow from the outside.

The retardation film 460 circularly polarizes light that pass through the optical film 100 to cause phase difference, and thus may affect reflection and absorption of light. The retardation film 460 may be for example a λ/4 plate. The retardation film 460 may be omitted as needed.

The optical film 100 may be disposed on the light-emitting side. For example, in the case of a bottom emission structure emitting light at the side of the base substrate 410, the optical film 100 may be disposed on the exterior side of the base substrate 410, while in the case of a top emission structure emitting light at the side of the encapsulation substrate 450, the optical film 100 may be disposed on the exterior side of the encapsulation substrate 450.

The retardation film 460 and the optical film 100 converts incident unpolarized light from outside into linear polarized light and circularly polarized light and may have external light anti-reflection effect.

Hereinafter, the present disclosure is illustrated in more detail with reference to examples. However, these examples are exemplary, and the present disclosure is not limited thereto.

### Manufacture of Optical Film

### EXAMPLE 1

A composition is prepared by mixing dichroic dyes represented by Chemical Formulae A, B, and C in amount of 0.5, 0.2, and 0.3 parts by weight, respectively, based on 100 parts by weight of the polypropylene (HU300, Samsung Total Petrochemicals Co., Ltd.).

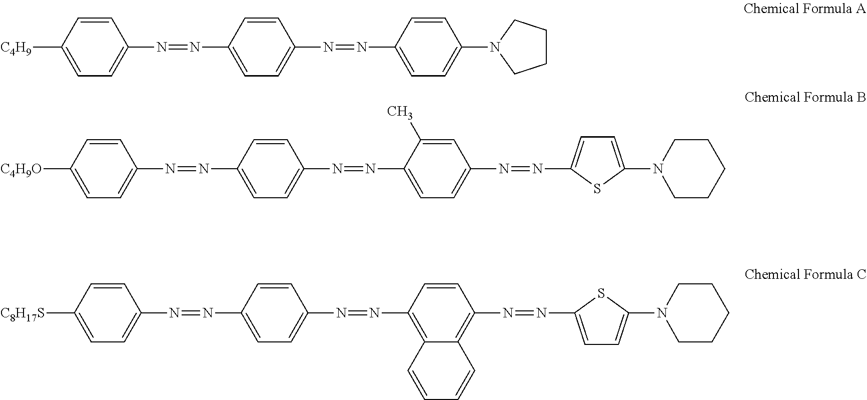

The composition is melt-blended at about 250° C. by using a micro-compounder made by DSM. The melt blend is placed in a sheet-shaped mold and pressed with high temperature and pressure to form a film. Subsequently, the film is elongated by 1,000% (with a tensile tester made by Instron) in a uniaxial direction at 115° C., obtaining a 20 micrometer (um)-thick elongation film.

The elongation film is bonded with a brightness enhancement film (26 μm, 3M) an adhesive (PS-47, Soken Chemical & Engineering Co., Ltd.) to manufacture an optical film.

### COMPARATIVE EXAMPLE 1

An optical film is manufactured by elongating a polyvinyl alcohol film (PS 60, Kuraray Co., Ltd.) at 25 micrometers (μm) and, respectively, attaching a TAC film (each thickness of 50 μm and 80 μm, Fuji Film Corp.) at both sides of the elongated polyvinyl alcohol film.

### Evaluation 1

The optical films according to Example 1 and Comparative Example 1 are evaluated regarding transmittance, degree of polarization, and thickness.

The transmittance and the degree of polarization are measured by using a UV-VIS spectrophotometer (V-7100, JASCO Co., Ltd.).

The results are shown in Table 1.

TABLE 1

| | Thickness | Transmittance | Degree of |
|---|---|---|---|
| | (μm) | (%) | polarization (%) |
| Example 1 | 46 | 41.9 | 99.94 |
| Comparative | 155 | 42.5 | 99.99 |
| Example 1 | | | |

Referring to Table 1, the optical film according to Example 1 has an equivalent transmittance and degree of polarization as the optical film according to Comparative Example 1.

### Manufacture of Display Device

### EXAMPLE 2

A liquid crystal display (LCD) is manufactured by attaching a polyvinyl alcohol polarizer impregnated with iodine on the front side of a liquid crystal display panel (LTN101AL03, Samsung) and the optical film of Example 1 on the rear side thereof.

### COMPARATIVE EXAMPLE 2

A liquid crystal display (LCD) is manufactured by attaching a polyvinyl alcohol polarizer impregnated with iodine on the front side of a liquid crystal display panel (LTN101AL03, Samsung) and the optical film of Comparative Example 1 on the rear side thereof.

### Evaluation 2

The brightness of the liquid crystal displays (LCD) according to Example 2 and Comparative Example 2 are evaluated.

The brightness is measured by using SR-UL2 (TOP-CON Corp.).

The results are shown in Table 2.

TABLE 2

| | Brightness |
|---|---|
| Example 2 | 418 |
| Comparative | 306 |
| Example 2 | |

Referring to Table 2, the liquid crystal display (LCD) according to Example 2 shows greater than or equal to about 30% improved brightness compared with the liquid crystal display (LCD) according to Comparative Example 2.

Referring to the results of Tables 1 and 2, the liquid crystal display (LCD) manufactured by using the optical film according to Example 1 has a largely reduced thickness but much improved brightness. Accordingly, a thin liquid crystal display (LCD) having improved brightness may be realized.

While this disclosure has been described in connection with what is presently considered to be practical exemplary embodiments, it is to be understood that the present inventive concept is not limited to the disclosed embodiments, but, on the contrary, is intended to cover various modifications and equivalent arrangements included within the spirit and scope of the appended claims.

What is claimed is:

1. An optical film comprising:
an elongation film comprising a hydrophobic polymer and a dichroic dye, and
a brightness enhancement film disposed on the elongation film.

2. The optical film of claim 1, wherein the elongation film is a melt-blend of the hydrophobic polymer and the dichroic dye, and wherein the elongation film is elongated in a uniaxial direction.

3. The optical film of claim 1, wherein the hydrophobic polymer comprises a polyolefin, a polyamide, a polyester, a polyacryl, a polystyrene, a copolymer thereof, or a combination thereof.

4. The optical film of claim 1, wherein the dichroic dye is represented by Chemical Formula 1: 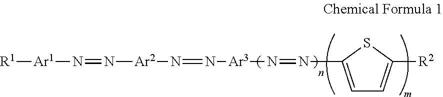
wherein, in Chemical Formula 1,
Ar¹ to Ar³ are independently a substituted or unsubstituted C6 to C15 arylene group,
R¹ is a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof,
R² is hydrogen, a substituted or unsubstituted C1 to C30 aliphatic organic group, a substituted or unsubstituted C1 to C30 aromatic organic group, a substituted or unsubstituted C1 to C30 heteroaliphatic organic group, a substituted or unsubstituted C1 to C30 heteroaromatic organic group, or a combination thereof, and
n and m are independently 0 or 1.

5. The optical film of claim 1, wherein the elongation film has a thickness of less than or equal to about 50 micrometers.

6. The optical film of claim 1, wherein the brightness enhancement film comprises a plural layer having different refractive indices.

7. The optical film of claim 1, wherein the brightness enhancement film comprises a plurality of light transmittance particulates.

8. The optical film of claim 1, wherein the brightness enhancement film comprises a plurality of anisotropic particles.

9. The optical film of claim 1, wherein the brightness enhancement film comprises a liquid crystal.

10. The optical film of claim 1, wherein the brightness enhancement film comprises a nano wire grid polarizer.

11. The optical film of claim 1, wherein the brightness enhancement film comprises a multi-layered reflection polarizer.

12. The optical film of claim 1, wherein the elongation film and the brightness enhancement film are directly bonded to each other or are interposed by an adhesive or a bonding agent.

13. The optical film of claim 1, wherein the optical film satisfies transmittance of about 20% to about 50% and a degree of polarization of greater than or equal to about 90%.

14. The optical film of claim 1, wherein the optical film has a thickness of about 30 micrometers to about 100 micrometers.

15. A display device comprising:
a display panel, and
the optical film of claim 1 disposed on the display panel.

16. The display device of claim 15, wherein the display panel is a liquid crystal display panel or an organic light emitting display panel.

17. A display device comprising:
a light source,
a liquid crystal display panel, and
the optical film of claim 1 disposed between the light source and the liquid crystal display panel.

18. The display device of claim 17, wherein the elongation film is disposed on the liquid crystal display panel, and
the brightness enhancement film is disposed on the light source.
